(19) United States
(12) Patent Application Publication
(10) Pub. No.: US 2023/0100688 A1
(43) Pub. Date: Mar. 30, 2023

(54) EARPHONE PROTECTIVE CASE

(71) Applicant: Sijun Hou, Foshan,Guangdong (CN)

(72) Inventor: Sijun Hou, Foshan,Guangdong (CN)

(21) Appl. No.: 17/442,592

(22) PCT Filed: May 10, 2021
(86) PCT No.: PCT/CN2021/092612

§ 371 Date: Sep. 23, 2021

(30) Foreign Application Priority Data
Dec. 18, 2020 (CN) 2020230871303

(51) Int. Cl. A45C 11/00; H04M 1/04; H04R 1/10

(52) U.S. Cl. CPC A45C 11/00; H04M 1/04; H04R 1/1025; A45C 2011/001

(57) ABSTRACT

The invention relates to an earphone protective case comprises a protective case body and a cover which is arranged at one end of the protective case body and is detachably connected with the protective case body; one side of said protective case body is provided with a groove and a slide, two sides of said groove are provided with a sliding track, two sides of said slide is matched with the sliding track of the groove and can slide in the sliding track at two sides of said groove; the other end of the slide that is close to the protective case body is provided with a hook that is matched with the shape of the other end of protective case body; after the slide is taken out, a support frame that can support the mobile phone is formed between said hook and other end of said protective case body.

### BACKGROUND OF THE INVENTION

### 1. Field of the Invention

The invention relates to an earphone protective case.

### 2. Description of the Related Art

The existing earphone protective case comprises a protective case body and a cover which is arranged at one end of the protective case body and is detachably connected with the protective case body to serve as a role of protecting earphones, which is single in function. Along with the widespread use of the mobile phones, the earphones are more frequently matched with mobile phones, and when mobile phone is used in many occasions, earphones are required to be used so as to not influence other people; accordingly, if the earphone protective case can both protect the earphones and has a new function, it will significantly expand the use scope of the earphone protective case and make it more popular among consumers.

### SUMMARY OF THE INVENTION

The invention provides an earphone protective case to solve the technical problem of single function in current earphone protective case.

In order to solve said technical problem, the invention discloses the following technical solution:

an earphone protective case comprises a protective case body and a cover which is arranged at one end of the protective case body and is detachably connected with the protective case body, which is characterized in that: one side of said protective case body is provided with a groove and a slide, two sides of said groove are provided with a sliding track, two sides of said slide is matched with the sliding track of the groove and can slide in the sliding track at two sides of said groove; the other end of the slide that is close to the protective case body is provided with a hook that is matched with the shape of the other end of the protective case body; after the slide is taken out, a support frame that can support the mobile phone is formed between said hook and the other end of said protective case body.

Rubber soft pads are arranged on the inner layer and the bottom of said protective case body.

Said protective case body is made of rigid plastic.

The other end of said protective case body is provided with a charging port.

At the charging port of said protective case body is also provided with a dustproof plug.

After adopting above-mentioned technical solution, one side of said protective case body is provided with a groove and a slide, two sides of said groove are provided with a sliding track, two sides of said slide is matched with the sliding track of the groove and can slide in the sliding track at two sides of said groove; the slide that is close to the other end of the protective case body is provided with a hook that is matched with the shape of the other end of the protective case body; after the slide is taken out, a support frame that can support the mobile phone is formed between said hook and the other end of said protective case body. Therefore, it can not only protect the earphone, but also serve as the mobile phone support, solving the technical problem of single function in current earphone protective case. And secondly, the arrangement of the rubber soft pads on the inner layer and the bottom of the protective case body can better protect the earphone from being scratched by hard bodies.

### BRIEF DESCRIPTION OF THE DRAWINGS

FIG. 1 is a schematic view of the three-dimensional structure of the invention.

FIG. 2 is a schematic structural view of the cover and the dustproof plug 6 of the invention in an open state.

FIG. 3 is a schematic structural view of the slide 5 of the invention in an open state.

FIG. 4 is a schematic structural view of the slide 5 of the invention in an open state for supporting a mobile phone.

FIG. 5 is a schematic structural perspective view of the slide 5 of the invention in an open state for supporting the mobile phone.

FIG. 6 is a schematic structural view of the slide 5 of the invention in an open state for supporting the side of the mobile phone.

In the drawings, 1-protective case body; 2-cover; 3-groove; 4-sliding track; 5-slide; 6-dustproove plug; 7-mobile phone.

### DETAILED DESCRIPTION OF THE PREFERRED EMBODIMENTS

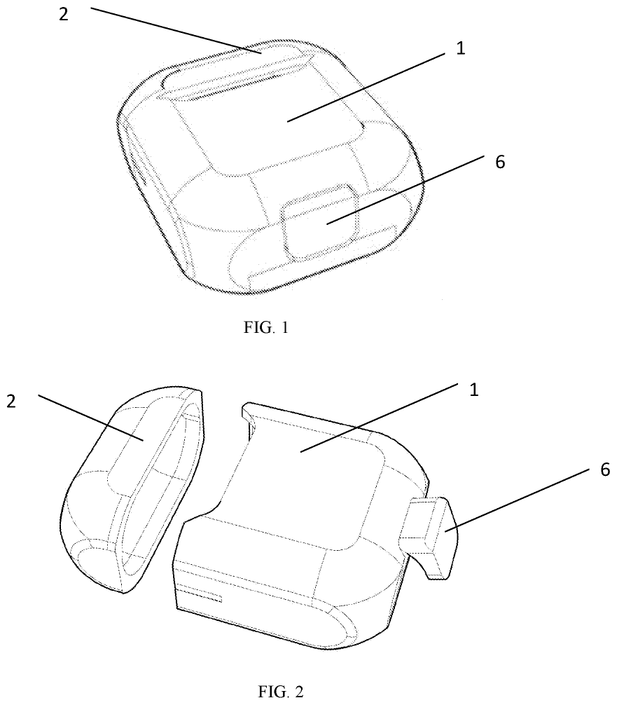

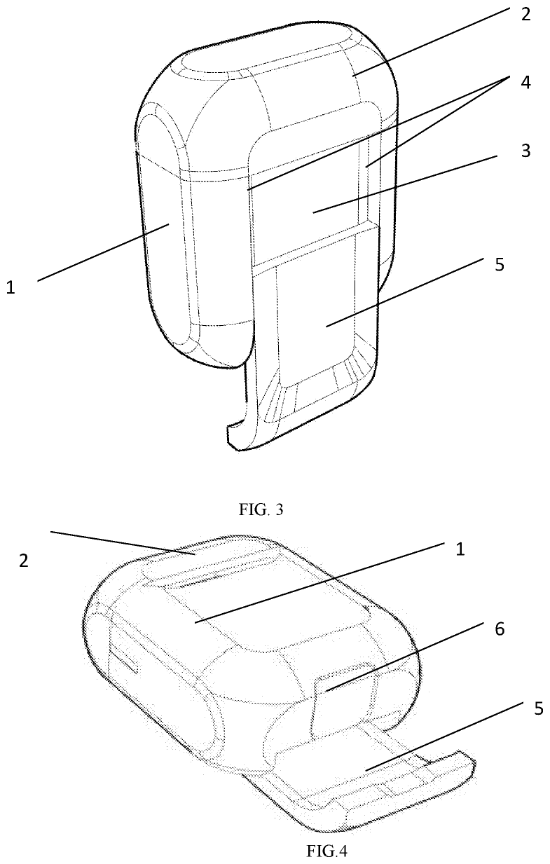

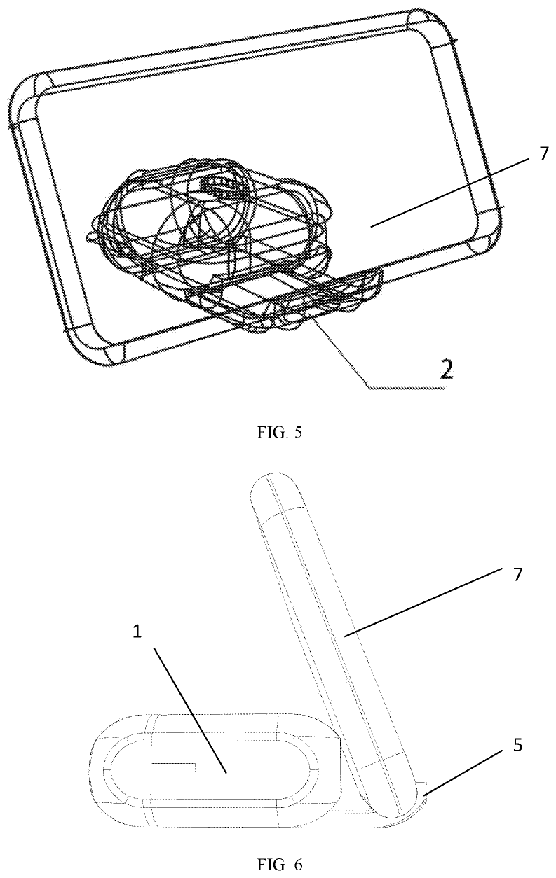

As is shown from FIG. 1 to FIG. 6, an earphone protective case comprises a protective case body 1 and a cover 2 which is arranged at one end of the protective case body 1 and is detachably connected with the protective case body 1, which is characterized in that: one side of said protective case body 1 is provided with a groove 3 and a slide 5, two sides of said groove 3 are provided with a sliding track 4, two sides of said slide 5 is matched with the sliding track of the groove 3 and can slide in the sliding track 4 at two sides of said groove 3; the slide 5 that is close to the other end of the protective case body 1 is provided with a hook that is matched with the shape of the other end of the protective case body 1; after the slide 5 is taken out, a support frame that can support the mobile phone 7 is formed between said hook and the other end of said protective case body 1, as are shown in FIGS. 4, 5 and 6. Rubber soft pads are arranged on the inner layer and the bottom of said protective case body 1 to improve safety of the earphone. Said protective case body is made of rigid plastic, which is dirt-resistant and enhances hand feeling. The other end of said protective case body 1 is provided with a charging port and at the charging port of said protective case body 1 is also provided with a dustproof plug 6. As one side of said protective case body 1 is provided with a groove 3 and a slide 5, two sides of said groove 3 are provided with a sliding track 4, two sides of said slide 5 is matched with the sliding track of the groove 3 and can slide in the sliding track 4 at two sides of said groove 3; the slide 5 that is close to the other end of the protective case body 1 is provided with a hook that is matched with the shape of the other end of the protective case body 1; after the slide 5 is taken out, a support frame that can support the mobile phone 7 is formed between said hook and the other end of said protective case body 1. Therefore, it can not only protect the earphone, but also serve as the mobile phone support, solving the technical problem of single function in current earphone protective case. And secondly, the arrangement of the rubber soft pads on the inner layer and the bottom of the protective case body can better protect the earphone from being scratched by hard bodies. The invention also has following advantages: the structure is simple and compact, small in size is not stained with the ash, and good hand feeling; when used outside, it can directly be turned into support of mobile phone 7 from the protective case, which can be used in horizontally and vertically, and no additional support needed, in this way, the comprehensiveness and the functional of earphone protection has improved and the flexibility of mobile phone 7 is also improved, having extensive use prospect.

1. An earphone protective case comprising a protective case body and a cover which is arranged at one end of the protective case body and is detachably connected with the protective case body, which is characterized in that: one side of said protective case body is provided with a groove and a slide, two sides of said groove are provided with a sliding track, two sides of said slide is matched with the sliding track of the groove and can slide in the sliding track at two sides of said groove; the other end of the slide that is close to the protective case body is provided with a hook that is matched with the shape of the other end of the protective case body; after the slide is taken out, a support frame that can support the mobile phone is formed between said hook and the other end of said protective case body.

2. The earphone protective case of claim 1 wherein said rubber soft pads are arranged on the inner layer and the bottom of said protective case body.

3. The earphone protective case of claim 1 wherein said protective case body is made of rigid plastic.

4. The earphone protective case of claim 1 wherein the other end of said protective case body is provided with a charging port.

5. The earphone protective case of claim 1 wherein at the charging port of said protective case body is also provided with a dustproof plug.
